(19) United States
(12) Patent Application Publication
(10) Pub. No.: US 2024/0135243 A1
(43) Pub. Date: Apr. 25, 2024

(54) CONTRASTIVE LEARNING METHOD BASED ON IMPLICATIONS FOR DETECTING IMPLICIT HATE EXPRESSION, APPARATUS AND COMPUTER PROGRAM FOR PERFORMING THE METHOD

(71) Applicant: UIF (University Industry Foundation), Yonsei University, Seoul (KR)

(72) Inventors: Yo-Sub Han, Seoul (KR); Youngwook Kim, Seoul (KR); Shinwoo Park, Seoul (KR)

(21) Appl. No.: 18/069,073

(22) Filed: Dec. 20, 2022

(30) Foreign Application Priority Data
Oct. 20, 2022 (KR) 10-2022-0136485

(51) Int. Cl. G06N 20/00

(52) U.S. Cl. CPC G06N 20/00

(57) ABSTRACT

The contrastive learning method based on implications for detecting implicit hate expression, an apparatus, and a computer program for performing the same according to the exemplary embodiment of the present disclosure perform the contrastive learning based on implications of implicit hate expression to detect the implicit hate expression to train a network model having a higher generalization performance for the implicit hate expression.

### CROSS-REFERENCE TO RELATED APPLICATIONS

This application claims priority to and the benefit of Korean Patent Application No. 10-2022-0136485 filed in the Korean Intellectual Property Office on Oct. 21, 2022, the entire contents of which are incorporated herein by reference.

### BACKGROUND

### Field

The present disclosure relates to a contrastive learning method based on implications for detecting implicit hate expression, an apparatus and a computer program for performing the same, and more particularly, to a method, an apparatus, and a computer program for training a model to detect hate expression. The present patent application has been filed as research projects as described below.

### [1] National Research Development Project Supporting the Present Invention

Project Serial No. 1711152953
Project No.: 2021-0-00354-002
Department: Ministry of Science and ICT
Project management (Professional) Institute: Institute of Information & Communication Technology Planning & Evaluation
Research Project Name: Information & Communication Broadcasting Research Development Project
Research Task Name: Artificial intelligence technology inferring issues and logically supporting facts from raw text(2/2)
Contribution Ratio: 1/2
Project Performing Institution: Changwon National University Industry-University

Cooperation Foundation
Research Period: 2022.01.01˜2022.12.31

### [2] National Research Development Project Supporting the Present Invention

Project Serial No. 1711152718
Project No.: 2020-0-01361-003
Department: Ministry of Science and ICT
Project management (Professional) Institute: Institute of Information & Communication Technology Planning & Evaluation
Research Project Name: Information & Communication Broadcasting Research Development Project
Research Task Name: Artificial Intelligence Graduate School Support Project (3/5)
Contribution Ratio: 1/2
Project Performing Institution: UIF (University Industry Foundation), Yonsei University
Research Period: 2022.01.01˜2022.12.31

### Description of the Related Art

In the case of a deep learning based detecting apparatus of the related art, a relationship between an input text and a correct answer label is trained by utilizing a cross entropy loss function. However, when this learning method is used, there are problems with generalization to cause the device to learn spurious correlations. Specifically, if the evaluation is conducted with a different dataset from a dataset used for the learning to deal with the same task, the performance may be significantly lower than the existing performance. For example, the evaluation is conducted with a different dataset which deals with the same task, the performance is significantly lowered. Such generalization problem may occur in detection of implicit hate expression with a lack superficial signal.

### SUMMARY

An object to be achieved by the present disclosure is to provide a contrastive learning method based on implications for detecting implicit hate expression, an apparatus and a computer program for performing the same to perform contrastive learning based on implications of implicit hate expression to detect implicit hate expression.

Other and further objects of the present disclosure which are not specifically described can be further considered within the scope easily deduced from the following detailed description and the effect.

In order to achieve the above-described technical objects, according to an aspect of the present disclosure, a contrastive learning method based on implications for detecting an implicit hate expression includes acquiring a plurality of input texts to be used as training data; acquiring a positive sample for each of the plurality of input texts and acquiring the training dataset based on the plurality of input texts and the positive sample for each of the plurality of input texts; and training a hate expression detection model using a contrastive loss function together with a cross entropy loss function, based on the training dataset.

Here, the acquiring of a training dataset is configured by acquiring a text which is semantically similar to the input text, but is superficially different from the input text as the positive sample for the input text when the input text is not a predetermined hate expression.

Here, the acquiring of a training dataset is configured by acquiring a text which represents an implication of the input text as the positive sample for the input text when the input text is a predetermined hate expression.

Here, the hate expression detection model includes: a first encoder which outputs an encoded expression value of the input text when the input text is input; a second encoder which outputs an encoded expression value of the positive sample when the positive sample for the input text is input; and a classifier which outputs a value representing whether the input text is a hate expression or not when the encoded expression value of the input text which is an output of the first encoder is input, the training of a hate expression detection model is configured by training the hate expression detection model based on the training dataset and removing the second encoder from the hate expression detection model when the training of the hate expression detection model is completed.

Here, the training of a hate expression detection model is configured by training the hat expression detection model by repeatedly training based on the cross entropy loss function which uses an output value of the classifier for the input text and a correct answer label corresponding to the input text and the contrastive loss function which uses an encoded expression value of the input text which is an output value of the first encoder for the input text and the encoded expression value of the positive sample which is an output value of the second encoder for the positive sample.

Here, the training of a hate expression detection model is configured by training the hate expression detection model using the cross entropy loss function L_{ce} as represented in Equation 1, Here, Equation 1 is L_{ce}=−(yᵢ·log y_{î}+(1−yᵢ)log(1−y_{î})), yᵢ is a correct answer label corresponding to an i-th input text and y_{î} is a prediction probability which is an output of the classifier for the input text.

Here, the training of a hate expression detection model is configured by training the hate expression detection model using the contrastive loss function L_{cl} as represented in Equation 2,

$${L}_{cl} = - {\sum }_{i = 1}^{2 N} log \frac{{e}^{h ( {x}^{i} ) \cdot h ( {x}_{pos}^{i} ) / τ}}{{\sum }_{k = 1}^{2 N} {1}_{[ k \neq i ]} {e}^{h ( {x}^{i} ) \cdot h ( {x}^{k} ) / τ}} \\ is \qquad Equation 2$$

N is a number of input texts, xⁱ is an i-th input text, xₚₒₛⁱ is a positive sample for the i-th input text, h(xⁱ) is an encoded expression value of the i-th input text, h(xⁱ)∈R^{H}, H is a hidden dimension size, l_{[⋅]} is an indicator function, and τ is a temperature hyperparameter which adjusts scaling of dot product.

In order to achieve the above-described technical objects, according to an aspect of the present disclosure, a computer program is stored in a computer readable storage medium to cause a computer to perform any one of a contrastive learning method based on implications for detecting an implicit hate expression.

In order to achieve the above-described technical objects, according to an aspect of the present disclosure, a contrastive learning apparatus based on implications for detecting an implicit hate expression includes a memory which stores one or more programs to execute contrastive learning based on implications of an implicit hate expression to detect an implicit hate expression; and one or more processors which perform an operation to perform contrastive learning based on implications of an implicit hate expression to detect an implicit hate expression according to one or more programs stored in the memory, the processor is configured to acquire a plurality of input texts to be used as training data; acquire a positive sample for each of the plurality of input texts and acquiring the training dataset based on the plurality of input texts and the positive sample for each of the plurality of input texts; and train a hate expression detection model using a contrastive loss function together with a cross entropy loss function, based on the training dataset.

Here, the processor acquires a text which is semantically similar to the input text, but is superficially different from the input text as the positive sample for the input text when the input text is not a predetermined hate expression.

The processor acquires a text which represents implication of the input text as the positive sample for the input text when the input text is a predetermined hate expression.

Here, the hate expression detection model includes: a first encoder which outputs an encoded expression value of the input text when the input text is input; a second encoder which outputs an encoded expression value of the positive sample when the positive sample for the input text is input; and a classifier which outputs a value representing whether the input text is a hate expression or not when the encoded expression value of the input text which is an output of the first encoder is input, the processor trains the hate expression detection model based on the training dataset and removes the second encoder from the hate expression detection model when the training of the hate expression detection model is completed

Here, the processor trains the hate expression detection model by repeatedly training based on the cross entropy loss function which uses an output value of the classifier for the input text and a correct answer label corresponding to the input text and the contrastive loss function which uses an encoded expression value of the input text which is an output value of the first encoder for the input text and the encoded expression value of the positive sample which is an output value of the second encoder for the positive sample.

According to the contrastive learning method based on implications for detecting implicit hate expression, an apparatus, and a computer program for performing the same according to the exemplary embodiment of the present disclosure, the contrastive learning is performed based on implications of implicit hate expression to detect the implicit hate expression to learn a network model having a higher generalization performance for the implicit hate expression.

The effects of the present invention are not limited to the technical effects mentioned above, and other effects which are not mentioned can be clearly understood by those skilled in the art from the following description

### BRIEF DESCRIPTION OF THE DRAWINGS

FIG. 1 is a block diagram for explaining a contrastive learning apparatus based on implications for detecting implicit hate expression according to an exemplary embodiment of the present disclosure;

FIG. 2 is a view for explaining implicit hate expressions according to an exemplary embodiment of the present disclosure and implications common for them;

FIG. 3 is a flowchart for explaining a contrastive learning method based on implications for detecting implicit hate expression according to an exemplary embodiment of the present disclosure;

FIG. 4 is a view for explaining a hate expression detection model illustrated in FIG. 3; and

FIG. 5 is a view for explaining an example a hate expression detection model illustrated in FIG. 3.

### DETAILED DESCRIPTION OF THE EMBODIMENT

Hereinafter, embodiments of the present disclosure will be described in detail with reference to the accompanying drawings. Advantages and characteristics of the present disclosure and a method of achieving the advantages and characteristics will be clear by referring to exemplary embodiments described below in detail together with the accompanying drawings. However, the present disclosure is not limited to exemplary embodiments disclosed herein, but will be implemented in various different forms. The exemplary embodiments are provided by way of example only so that a person of ordinary skilled in the art can fully understand the disclosures of the present invention and the scope of the present invention. Therefore, the present invention will be defined only by the scope of the appended claims. Like reference numerals generally denote like elements throughout the specification.

Unless otherwise defined, all terms (including technical and scientific terms) used in the present specification may be used as the meaning which may be commonly understood by the person with ordinary skill in the art, to which the present invention belongs. It will be further understood that terms defined in commonly used dictionaries should not be interpreted in an idealized or excessive sense unless expressly and specifically defined.

In the specification, the terms “first” and “second” are used to distinguish one component from the other component so that the scope should not be limited by these terms. For example, a first component may also be referred to as a second component and likewise, the second component may also be referred to as the first component.

In the present specification, in each step, numerical symbols (for example, a, b, and c) are used for the convenience of description, but do not explain the order of the steps so that unless the context apparently indicates a specific order, the order may be different from the order described in the specification. That is, the steps may be performed in the order as described or simultaneously, or an opposite order.

In this specification, the terms “have”, “may have”, “include”, or “may include” represent the presence of the characteristic (for example, a numerical value, a function, an operation, or a component such as a part”), but do not exclude the presence of additional characteristic.

Hereinafter, exemplary embodiments of a contrastive learning method based on implications for detecting an implicit hate expression according to the present disclosure, an apparatus and a computer program for performing the same will be described in detail with reference to accompanying drawings.

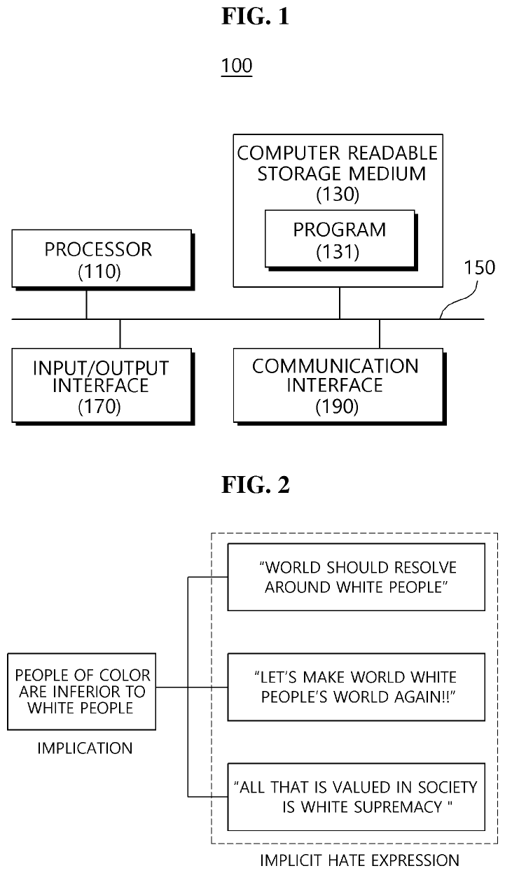

First, a contrastive learning apparatus based on implications for detecting an implicit hate expression according to an exemplary embodiment of the present disclosure will be described with reference to FIGS. 1 and 2.

FIG. 1 is a block diagram for explaining a contrastive learning apparatus based on implications for detecting implicit hate expression according to an exemplary embodiment of the present disclosure and FIG. 2 is a view for explaining implicit hate expressions according to an exemplary embodiment of the present disclosure and implications common for them.

Referring to FIG. 1, a contrastive learning apparatus 100 based on implications for detecting an implicit hate expression according to an exemplary embodiment of the present disclosure (hereinafter, simply referred to as “contrastive learning apparatus) conducts the contrastive learning based on implications of an implicit hate expression to detect the implicit hate expression.

Accordingly, the contrastive learning apparatus 100 trains a network model having a high generalization performance for an implicit hate expression.

That is, the present disclosure proposes a method of utilizing contrastive learning together with a cross entropy loss function to detect an implicit hate expression. The contrastive learning is a learning technique which brings related positive sample pairs closer together and unrelated negative sample pairs farther apart in the expression space of a deep learning model. It has been known that such a learning method increases the generalization performance when it is utilized together with a cross entropy loss function. Therefore, the present disclosure proposes to designate an implicit hate expression and an implication thereof as a positive sample pair to utilize the contrastive learning and the cross entropy loss function together.

The implicit hate expression and the implication thereof are as follows. Hate expression is performed based on a specific prejudice for a specific group. At this time, the specific prejudice for the specific group is considered as an (biased) implication of an implicit expression. Further, one implication may be frequently represented by several types of hate expressions. That is, a plurality of hate expressions may share one implication as illustrated in FIG. 2. From this characteristic, the contrastive learning which brings the hate expression and the implication thereof close together in an expression space may help to improve the generalization performance.

To this end, the contrastive learning apparatus 100 may include one or more processors 110, a computer readable storage medium 130, and a communication bus 150.

The processor 110 controls the contrastive learning apparatus 100 to operate. For example, the processor 110 may execute one or more programs 131 stored in the computer readable storage medium 130. One or more programs 131 include one or more computer executable instructions and when the computer executable instruction is executed by the processor 110, the computer executable instruction may be configured to allow the contrastive learning apparatus 100 to perform the contrastive learning based on implications of an implicit hate expression to detect the implicit hate expression.

The computer readable storage medium 130 is configured to store a computer executable instruction or program code, program data and/or other appropriate format of information to perform the contrastive learning based on implications of the implicit hate expression to detect the implicit hate expression. The program 131 stored in the computer readable storage medium 130 includes a set of instructions executable by the processor 110. In one exemplary embodiment, the computer readable storage medium 130 may be a memory (a volatile memory such as a random access memory, a non-volatile memory, or an appropriate combination thereof), one or more magnetic disk storage devices, optical disk storage devices, flash memory devices, and another format of storage media which are accessed by the contrastive learning apparatus 100 and store desired information, or an appropriate combination thereof.

The communication bus 150 interconnects various other components of the contrastive learning apparatus 100 including the processor 110 and the computer readable storage medium 130 to each other.

The contrastive learning apparatus 100 may include one or more input/output interfaces 170 and one or more communication interfaces 190 which provide an interface for one or more input/output devices. The input/output interface 170 and the communication interface 190 are connected to the communication bus 150. The input/output device (not illustrated) may be connected to the other components of the contrastive learning apparatus 100 by means of the input/output interface 170.

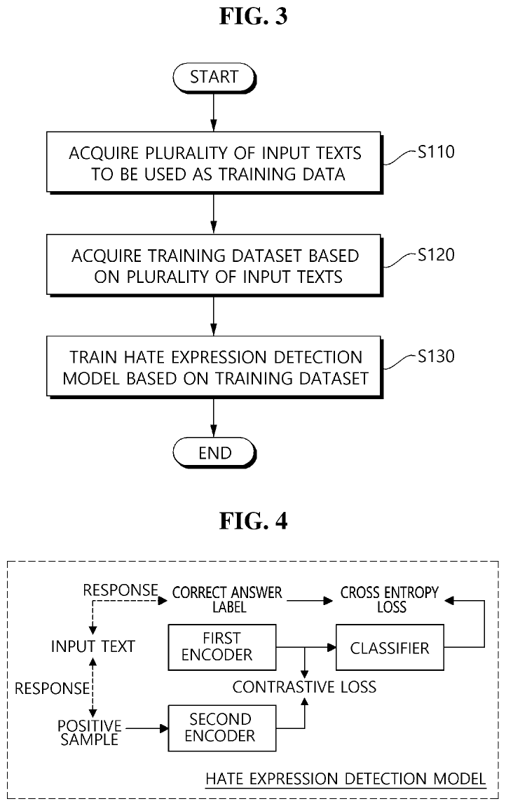

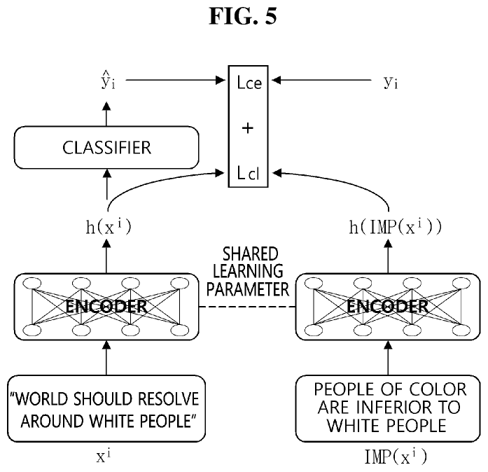

Now, a contrastive learning method based on implications for detecting an implicit hate expression according to an exemplary embodiment of the present disclosure will be described with reference to FIGS. 3 and 5.

FIG. 3 is a flowchart for explaining a contrastive learning method based on implications for detecting implicit hate expression according to an exemplary embodiment of the present disclosure, FIG. 4 is a view for explaining a hate expression detection model illustrated in FIG. 3, and FIG. 5 is a view for explaining an example a hate expression detection model illustrated in FIG. 3.

Referring to FIG. 3, a processor 110 of the contrastive learning apparatus 100 acquires a plurality of input texts to be used as training data in step S110.

Next, the processor 110 acquires a training dataset based on the plurality of input texts in step S120.

That is, the processor 110 acquires a positive sample for each of the plurality of input texts and acquires the training dataset based on the plurality of input texts and the positive sample for each of the plurality of input texts.

For example, the processor 110 may designate a positive sample IMP(x) for an input text x.

To be more specific, if the input text is not a predetermined hate expression, the processor 110 may acquire a text which is semantically similar to the input text, but is superficially different from the input text, as a positive sample for the input text. That is, the input text is augmented so that a text which is semantically similar to the input text, but is superficially different from the input text is designated as a positive sample. At this time, any data augmentation method which forms a text which is semantically similar to the input text, but is superficially different from the input text is applicable. For example, a word corresponding to a predetermined percentage of the input text is replaced with a corresponding synonym.

If the input text is a predetermined hate expression, the processor 110 acquires a text representing an implication of the input text as a positive sample for the input text. At this time, a text which is semantically similar to a part of the input text which is a predetermined hate expression, but is superficially different therefrom is designated as a positive sample for the input text.

Thereafter, the processor 110 trains the hate expression detection model based on a training dataset in step S130.

That is, the processor 110 trains the hate expression detection model using a contrastive loss function together with a cross entropy loss function, based on the training dataset.

Here, the hate expression detection model, as illustrated in FIGS. 4 and 5, includes a first encoder which outputs an encoded expressive value of an input text when the input text is input, a second encoder which outputs an encoded expressive value of a positive sample when the positive sample for the input text is input, and a classifier which outputs a value indicating whether the input text is a hate expression or not when the encoded expressive value of the input text which is an output of the first encoder is input.

At this time, the processor 110 trains the hate expression detection model based on the training dataset and when the learning of the hate expression detection model is completed, removes the second encoder from the hate expression detection model.

To be more specific, the processor 110 trains the hate expression detection model by repeatedly learning the training dataset based on the cross entropy loss function and the contrastive loss function.

Here, the cross entropy loss function uses an output value of the classifier for the input text and a correct answer label corresponding to the input text.

That is, the processor 110 trains the hate expression detection model using a cross entropy loss function L_{ce} as represented in Equation 1.

L_{ce}=−(yᵢ·log y_{î}+(1−yᵢ)log(1−ŷ_{î})) [Equation 1]

Here, yᵢ is a correct answer label corresponding to a i-th input text xⁱ (i≥1) in a mini batch of the training dataset. y_{î}y_{î} is a prediction probability which is an output of a classifier for the input text.

The contrastive loss function uses an encoded expression value of an input text which is an output value of the first encoder for the input text and an encoded expression value of a positive sample which is an output value of the second encoder for the positive sample.

That is, the processor 110 trains the hate expression detection model using a contractive loss function Li as represented in Equation 2.

$${L}_{cl} = - {\sum }_{i = 1}^{2 N} log \frac{{e}^{h ( {x}^{i} ) \cdot h ( {x}_{pos}^{i} ) / τ}}{{\sum }_{k = 1}^{2 N} {1}_{[ k \neq i ]} {e}^{h ( {x}^{i} ) \cdot h ( {x}^{k} ) / τ}} \qquad [ Equation 2 ]$$

Here, N is a number of input texts. xⁱ is an i-th input text in a mini batch of the training dataset. xₚₒₛⁱ is a positive sample for the i-th input text. That is, when there are N input texts for training in the mini batch of the training dataset, one positive sample is assigned to every input text and consequently, a total of 2N texts are present in the mini batch. For example, when i≤N, xₚₒₛⁱ=x^{i+N} and when i>N, xₚₒₛⁱ=x^{i-N}. At this time, the processor 110 uses 2N−2 texts remaining after excluding a positive sample pair from the mini batch of the training dataset as a negative sample pair. Further, the processor may assign the positive sample such that when i≤N, xₚₒₛⁱ=IMP(xⁱ) and i>N, IMP(xₚₒₛⁱ)=xⁱ. h(xi) is an encoded expression value of the i-th input text, h(xⁱ)∈R^{H}, and H is a hidden dimension size. l_{[⋅]} is an indicator function. τ is a temperature hyperparameter which adjusts scaling of dot product.

In summary, the processor 110 trains the hate expression detection model using a final loss function Lₒᵥₑᵣₐₗₗ represented in Equation 3 configured by a cross entropy loss function L_{ce} and a contrastive loss function L_{cl}.

Lₒᵥₑᵣₐₗₗ=λL_{ce}+(1−λ)L_{cl} [Equation 3]

Here, λ is a hyperparameter which adjusts a ratio between the cross entropy loss function L_{ce} and the contrastive loss function L_{cl}.

The operation according to the exemplary embodiment of the present disclosure may be implemented as a program instruction which may be executed by various computers to be recorded in a computer readable storage medium. The computer readable storage medium indicates an arbitrary medium which participates to provide a command to a processor for execution. The computer readable storage medium may include solely a program command, a data file, and a data structure or a combination thereof. For example, the computer readable medium may include a magnetic medium, an optical recording medium, and a memory. The computer program may be distributed on a networked computer system so that the computer readable code may be stored and executed in a distributed manner. Functional programs, codes, and code segments for implementing the present embodiment may be easily inferred by programmers in the art to which this embodiment belongs.

The present embodiments are provided to explain the technical spirit of the present embodiment and the scope of the technical spirit of the present embodiment is not limited by these embodiments. The protection scope of the present embodiments should be interpreted based on the following appended claims and it should be appreciated that all technical spirits included within a range equivalent thereto are included in the protection scope of the present embodiments.

What is claimed is:

1. A contrastive learning method based on implications for detecting an implicit hate expression, comprising:
acquiring a plurality of input texts to be used as training data;
acquiring a positive sample for each of the plurality of input texts and acquiring the training dataset based on the plurality of input texts and the positive sample for each of the plurality of input texts; and
training the hate expression detection model using a contrastive loss function together with a cross entropy loss function, based on the training dataset.

2. The contrastive learning method based on implications for detecting an implicit hate expression according to claim 1, wherein the acquiring of a training dataset is configured by acquiring a text which is semantically similar to the input text, but is superficially different from the input text as the positive sample for the input text when the input text is not a predetermined hate expression.

3. The contrastive learning method based on implications for detecting an implicit hate expression according to claim 2, wherein the acquiring of a training dataset is configured by acquiring a text which represents implication of the input text as the positive sample for the input text when the input text is a predetermined hate expression.

4. The contrastive learning method based on implications for detecting an implicit hate expression according to claim 3, wherein the hate expression detection model includes:
a first encoder which outputs an encoded expression value of the input text when the input text is input;
a second encoder which outputs an encoded expression value of the positive sample when the positive sample for the input text is input; and
a classifier which outputs a value representing whether the input text is a hate expression or not when the encoded expression value of the input text which is an output of the first encoder is input, and
the training of a hate expression detection model is configured by training the hate expression detection model based on the training dataset and removing the second encoder from the hate expression detection model when the training of the hate expression detection model is completed.

5. The contrastive learning method based on implications for detecting an implicit hate expression according to claim 4, wherein the training of a hate expression detection model is configured by training the hate expression detection model by repeatedly training based on the cross entropy loss function which uses an output value of the classifier for the input text and a correct answer label corresponding to the input text and the contrastive loss function which uses an encoded expression value of the input text which is an output value of the first encoder for the input text and the encoded expression value of the positive sample which is an output value of the second encoder for the positive sample.

6. The contrastive learning method based on implications for detecting an implicit hate expression according to claim 5, wherein the training of a hate expression detection model is configured by training the hate expression detection model using the cross entropy loss function L_{ce} as represented in Equation 1, Equation 1 is represented by
L_{ce}=−(yᵢ·log y_{î}+(1−yᵢ)log(1−ŷ_{î})),
yᵢ is a correct answer label corresponding to an i-th input text and y_{î} is a prediction probability which is an output of the classifier for the input text.

7. The contrastive learning method based on implications for detecting an implicit hate expression according to claim 6, wherein the training of a hate expression detection model is configured by training the hate expression detection model using the contrastive loss function L_{cl} as represented in Equation 2, Equation 2 is represented by
$${L}_{cl} = - {\sum }_{i = 1}^{2 N} log \frac{{e}^{h ( {x}^{i} ) \cdot h ( {x}_{pos}^{i} ) / τ}}{{\sum }_{k = 1}^{2 N} {1}_{[ k \neq i ]} {e}^{h ( {x}^{i} ) \cdot h ( {x}^{k} ) / τ}}$$
N is a number of input texts, xⁱ is an −th input text, xₚₒₛⁱ is a positive sample for the i-th input text, h(xⁱ) is an encoded expression value of the i-th input text, h(xⁱ)∈R^{H}, and H is a hidden dimension size, l_{[⋅]} is an indicator function, and τ is a temperature hyperparameter which adjusts scaling of dot product.

8. A computer program stored in a computer readable storage medium to cause a computer to execute the contrastive learning method based on implications for detecting an implicit hate expression according to claim 1.

9. A contrastive learning apparatus based on implications for detecting an implicit hate expression, comprising:
a memory which stores one or more programs to execute contrastive learning based on implications of an implicit hate expression to detect an implicit hate expression; and
one or more processors which perform an operation to perform contrastive learning based on implications of an implicit hate expression to detect an implicit hate expression according to one or more programs stored in the memory,
wherein the processor is configured to acquire a plurality of input texts to be used as training data, acquire a positive sample for each of the plurality of input texts and acquiring the training dataset based on the plurality of input texts and the positive sample for each of the plurality of input texts, and train a hate expression detection model using a contrastive loss function together with a cross entropy loss function, based on the training dataset.

10. The contrastive learning apparatus based on implications for detecting an implicit hate expression according to claim 9, wherein the processor acquires a text which is semantically similar to the input text, but is superficially different from the input text as the positive sample for the input text when the input text is not a predetermined hate expression.

11. The contrastive learning apparatus based on implications for detecting an implicit hate expression according to claim 10, wherein the processor acquires a text which represents implication of the input text as the positive sample for the input text when the input text is a predetermined hate expression.

12. The contrastive learning apparatus based on implications for detecting an implicit hate expression according to claim 11, wherein the hate expression detection model includes:
a first encoder which outputs an encoded expression value of the input text when the input text is input;
a second encoder which outputs an encoded expression value of the positive sample when the positive sample for the input text is input; and
a classifier which outputs a value representing whether the input text is a hate expression or not when the encoded expression value of the input text which is an output of the first encoder is input, and
the processor trains the hate expression detection model based on the training dataset and removes the second encoder from the hate expression detection model when the training of the hate expression detection model is completed.

13. The contrastive learning apparatus based on implications for detecting an implicit hate expression according to claim 12, wherein the processor trains the hate expression detection model by repeatedly training based on the cross entropy loss function which uses an output value of the classifier for the input text and a correct answer label corresponding to the input text and the contrastive loss function which uses an encoded expression value of the input text which is an output value of the first encoder for the input text and the encoded expression value of the positive sample which is an output value of the second encoder for the positive sample.
